(19) United States
(12) Patent Application Publication
(10) Pub. No.: US 2017/0322607 A1
(43) Pub. Date: Nov. 9, 2017

(54) PROGRAMMABLE LOGIC CONTROLLER SYSTEM

(71) Applicant: Mitsubishi Electric Corporation, Tokyo (JP)

(72) Inventor: Satoshi KAWANA, Tokyo (JP)

(73) Assignee: Mitsubishi Electric Corporation, Tokyo (JP)

(21) Appl. No.: 15/525,095

(22) PCT Filed: Dec. 3, 2014
(86) PCT No.: PCT/JP2014/082043

§ 371 Date: May 8, 2017

(51) Int. Cl. G06F 1/20; G05B 19/048; G05B 19/05; G05D 23/19

(52) U.S. Cl. CPC G06F 1/206; G05D 23/1917; G05B 19/048; G05B 19/05; G05B 2219/21156

(57) ABSTRACT

There is provided a central operation processing unit including a temperature control management unit that compares a temperature value detected by a temperature monitoring unit of a functional unit in a basic block with a prescribed value corresponding to the functional unit in the basic block and being set in advance individually, and, on the basis of a result of the comparison, controls an operation of the cooling unit of the functional unit from which the temperature value compared with the prescribed value is detected.

### FIELD

The present invention relates to a programmable logic controller system in which a plurality of units is connected.

### BACKGROUND

A conventional programmable logic controller (PLC) system has a basic block in which a power supply unit is arranged on a starting end, a central processing unit (CPU) is connected next to the power supply unit, and an input/output unit or another unit having another function is connected to the CPU unit. The units are connected by a base unit for performing communication inside and outside the PLC system.

When the PLC system in which the CPU unit and the other unit are connected as described above is up and running, current flowing through a substrate and a component within the unit causes the component to generate heat. The function and performance of the component or the unit as well as the life of the component are reduced when the component continues to be heated to cause a significant increase in temperature inside the unit. Therefore, in order for the PLC system to operate normally, it is required that the temperature inside the unit is not increased significantly by the heating of the component inside the unit.

Patent Literature 1 discloses a method of managing the temperature of the unit in the PLC system in which a data transfer path is provided between a CPU unit of a main body device and each of a power supply unit in the main body device and a power supply unit in an extension device. Each power supply unit includes a temperature sensor to measure internal temperature only at turn-on of the power supply unit and after data is transferred to the CPU unit in response to a command from the CPU, and store data in a non-volatile internal memory inside the power supply unit.

### CITATION LIST

### Patent Literature

Patent Literature 1: Japanese Patent Application Laid-Open No. 2006-294007

### SUMMARY

### Technical Problem

A PLC system of Patent Literature 1 however monitors temperature of only the power supply unit. Accordingly, internal temperature of a plurality of other units cannot be managed even when the temperature is increased, in which case the system cannot perform control to inhibit the increase in temperature of the units.

A temperature value inside the PLC system can be measured by implementing a temperature monitoring function in the PLC system as with the PLC system of Patent Literature 1. However, the PLC system of Patent Literature 1 continuously monitors the temperature inside the power supply unit and thus consumes more power during operation. The increase in power consumption increases the cost of operating the PLC system and thus administrative costs of the PLC system.

The present invention has been made in consideration of the aforementioned circumstances, where an object of the invention is to obtain a PLC system, in which the CPU unit is connected to a unit having another function, which can control the temperature value inside the unit with low power consumption.

### Solution to Problem

In order to solve the above-mentioned problems and achieve the object, according to an aspect of the present invention, there is provided a programmable logic controller system including a basic block in which, as functional units, a power supply unit, a central processing unit, a general unit having a different function from each of the power supply unit and the central processing unit among the functional units, and a first end unit arranged at an end with respect to the power supply unit are arranged adjacent to one another in sequence while in contact with one another and are electrically and communicably connected via a connector connecting the functional units, wherein the general unit includes: a temperature monitoring unit to intermittently detect a temperature value of the interior of the functional units at a predetermined timing; and a cooling unit to cool the interior of the functional units, and the central processing unit includes: the temperature monitoring unit; the cooling unit; and a temperature control management unit to compare the temperature value detected by the temperature monitoring unit of any of the functional units in the basic block with a prescribed value corresponding to the functional unit in the basic block and being set in advance individually, and, on the basis of a result of the comparison, control an operation of the cooling unit of the functional unit from which the temperature value compared with the prescribed value is detected.

### Advantageous Effects of Invention

The PLC system according to the present invention in which the CPU unit is connected to the unit having another function can control the temperature value inside the unit with low power consumption.

### BRIEF DESCRIPTION OF DRAWINGS

FIG. 1 is a diagram schematically illustrating an example of the configuration of a PLC system according to a first embodiment of the present invention.

FIG. 2 is a block diagram schematically illustrating a functional configuration of a CPU unit according to the first embodiment of the present invention.

FIG. 3 is a block diagram schematically illustrating a functional configuration of a target unit and an end cover according to the first embodiment of the present invention.

FIG. 4 is a block diagram schematically illustrating a functional configuration of a temperature monitoring unit according to the first embodiment of the present invention.

FIG. 5 is a block diagram schematically illustrating a functional configuration of a temperature control management unit according to the first embodiment of the present invention.

FIG. 6 is a flowchart illustrating an example of a procedure of temperature control processing performed in a unit of the PLC system according to the first embodiment of the present invention.

FIG. 7 is a flowchart illustrating an example of a procedure of internal temperature value detection processing and cooling control processing to be performed on a target unit according to the first embodiment of the present invention, the processing being included in the temperature control processing performed in the unit.

FIG. 8 is a diagram schematically illustrating an example of the configuration of a PLC system according to a second embodiment of the present invention.

FIG. 9 is a flowchart illustrating an example of a procedure of temperature monitoring processing according to the second embodiment of the present invention.

### DESCRIPTION OF EMBODIMENTS

In the following, a programmable logic controller system according to a first embodiment of the present invention will be described in detail with reference to the drawings. Note that the present invention is not to be limited by the embodiment.

### First Embodiment

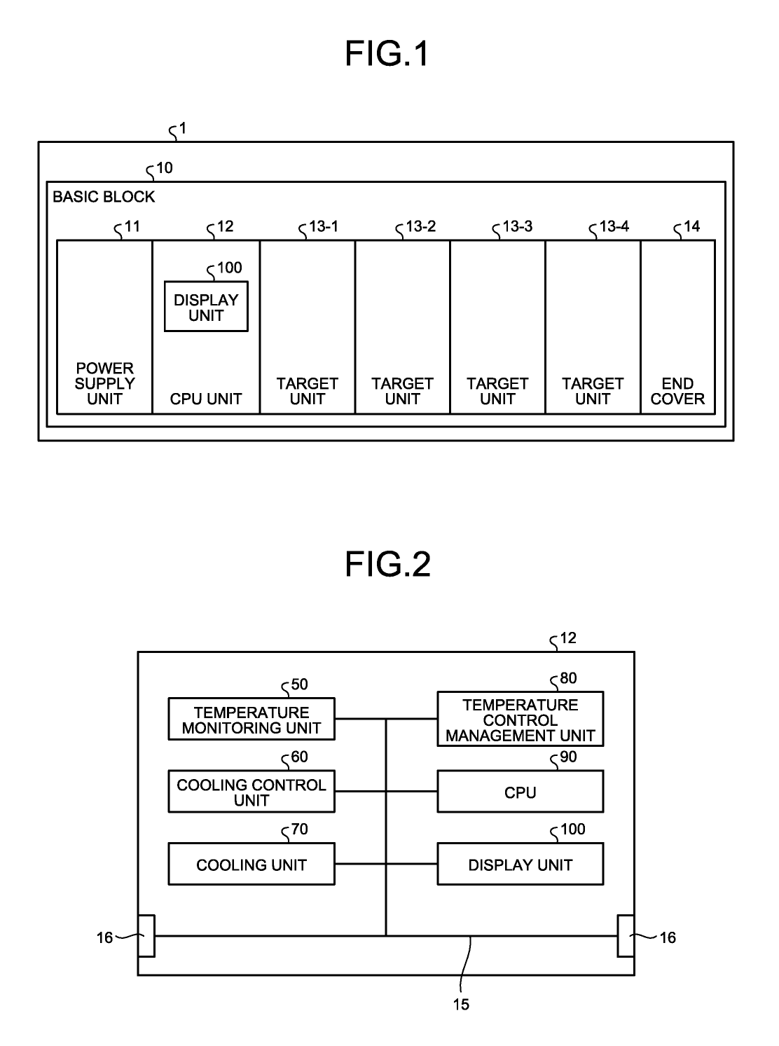

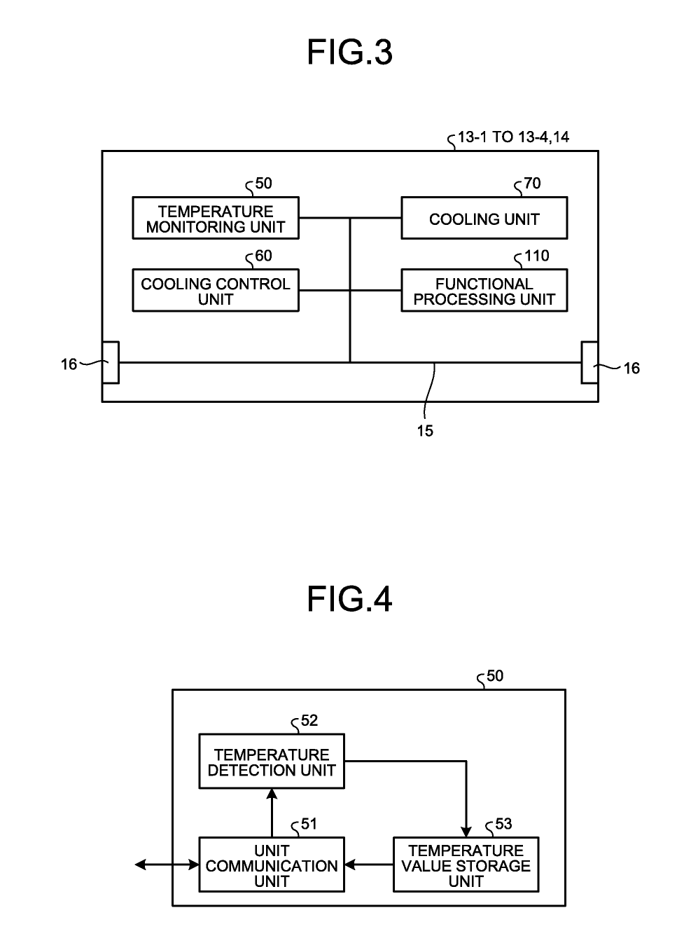

FIG. 1 is a diagram schematically illustrating an example of the configuration of a PLC system 1 according to the first embodiment of the present invention. FIG. 2 is a block diagram schematically illustrating a functional configuration of a CPU unit 12 according to the first embodiment. FIG. 3 is a block diagram schematically illustrating a functional configuration of target units 13-1 to 13-4 and an end cover 14 according to the first embodiment. The PLC system 1 has a direct unit connection structure in which units arranged adjacent to each other are directly connected while in contact with each other. The PLC system 1 includes one basic block 10. The basic block 10 includes, as functional units having individual functions, a power supply unit 11 which supplies a voltage to units within the basic block 10, the CPU unit 12 which manages the entire PLC system, the target units 13-1 to 13-4 each of which is an input/output unit or a general unit having another function, and the end cover 14 which is an end unit indicating the end of the block and performing end processing of the block.

All of the power supply unit 11, the CPU unit 12, the target units 13-1 to 13-4 and the end cover 14 being the end unit are connected via a bus connector 16 connected to an internal bus 15 within each unit while the units arranged adjacent to each other are in contact with each other. Each of the internal bus 15 within each unit and the bus connector 16 connecting the adjacent units functions as a voltage supply line and a signal transmission path used in information communication among the units. Components within each unit are connected by the internal bus 15. The units can communicate information with one another via the internal bus 15 and the bus connector 16. Moreover, the power supply unit 11 supplies a voltage to another unit via the internal bus 15 and the bus connector 16. While the four target units 13-1 to 13-4 are arranged in this example, the number of target units is not limited to four units.

The power supply unit 11 supplies a voltage to the CPU unit 12 connected thereto via the bus connector 16. The power supply unit 11 further supplies a voltage to the target units 13-1 to 13-4 and the end cover 14 via the CPU unit 12. That is, the power supply unit 11 supplies a voltage to the CPU unit 12 down to the end cover 14 via the internal bus 15 within each unit and the bus connector 16 connecting the adjacent units.

As illustrated in FIG. 2, the CPU unit 12 includes a temperature monitoring unit 50 that intermittently detects a temperature value inside a functional unit at a predetermined timing, a cooling control unit 60 that controls cooling processing within the functional unit, a cooling unit 70 that performs the cooling processing within the functional unit, a temperature control management unit 80 that compares the temperature value detected by the temperature monitoring unit 50 of the functional unit with a prescribed value corresponding to the functional unit and being set in advance individually and controls an operation of the cooling unit 70 of the functional unit, from which the temperature value compared with the prescribed value is detected, on the basis of a result of the comparison, a CPU 90 that manages control in the CPU unit 12 and the entire PLC system, and a display unit 100 that displays the temperature value inside each unit. The temperature control management unit 80 manages temperature monitoring processing and the cooling processing of the functional unit 12. The CPU unit 12 can communicate with another unit via a communication unit not shown. The temperature monitoring unit 50, the cooling control unit 60, the temperature control management unit 80 and the CPU 90 can be composed of an electronic circuit with use of a microcomputer.

As illustrated in FIG. 3, the target units 13-1 to 13-4 and the end cover 14 each includes the temperature monitoring unit 50, the cooling control unit 60, the cooling unit 70, and a functional processing unit 110 that executes functional processing unique to each unit. The target units 13-1 to 13-4 and the end cover 14 can each communicate with another unit via a communication unit not shown.

FIG. 4 is a block diagram schematically illustrating a functional configuration of the temperature monitoring unit 50 according to the first embodiment. The temperature monitoring unit 50 includes a unit communication unit 51 that is a communication function unit, a temperature value detection unit 52 that detects the internal temperature value of the unit, and a temperature value storage unit 53 that is a storage unit storing the temperature value. The temperature monitoring unit 50 can be composed of an electronic circuit with use of an integrated circuit (IC).

The unit communication unit 51 has a function of communicating information with another unit via the internal bus 15 and the bus connector 16. The unit communication unit 51 also functions as a communication unit between an own unit and another unit in addition to performing communication between the temperature monitoring unit 50 and another unit. The unit communication unit 51 may thus be provided separately from the temperature monitoring unit 50.

The temperature value detection unit 52 includes a temperature sensor that detects the internal temperature value of the unit, namely a temperature value inside the unit. The temperature value detection unit 52 uses the temperature sensor to perform monitoring processing, namely detection processing, of the internal temperature value of the unit. The temperature value detection unit 52 outputs the temperature value corresponding to a value detected by the temperature sensor. The temperature value detection unit 52 detects the temperature value inside the unit on the basis of unit internal temperature value detection instruction information being input from the CPU unit 12 and providing an instruction to detect the temperature inside the unit. The temperature value output from the temperature value detection unit 52 is input and stored into the temperature value storage unit 53 in the unit from which the temperature is detected. The temperature value inside the unit corresponds to a temperature of the internal atmosphere of the unit.

A temperature sensor such as a thermistor or thermocouple can be employed as the temperature sensor of the temperature value detection unit 52. When the thermistor is employed as the temperature sensor, the temperature value detection unit 52 can be composed by including a circuit that measures an electrical resistance value of the thermistor and a circuit that converts the measured electrical resistance value into the temperature value. On the other hand, when the thermocouple is employed as the temperature sensor, the temperature value detection unit 52 can be composed by including a circuit that measures an electromotive force of the thermocouple and a circuit that converts the measured electromotive force into the temperature value.

The temperature sensor may be installed at any site as long as the temperature inside the unit can be detected. The temperature sensor is installed near a heat generating component in the unit, for example. The temperature sensor may also be installed at a plurality of sites within the unit, in which case the temperature value detection unit 52 may generate a temperature value by performing a predetermined computation such as averaging on values output from the plurality of temperature sensors.

The temperature value storage unit 53 stores the temperature value inside the unit, the temperature value being detected by the temperature value detection unit 52.

The cooling control unit 60 controls the operation of the cooling unit 70 on the basis of cooling unit operation instruction information being input from a comparison unit 83 (to be described) and providing an instruction to bring the cooling unit 70 into operation or maintain an operating state thereof. The cooling control unit 60 further controls suspension of the cooling unit 70 on the basis of cooling unit suspension instruction information being input from the comparison unit 83 and providing an instruction to suspend the operation of the cooling unit 70 or maintain a suspended state thereof. The cooling control unit 60 can be composed of an electronic circuit with use of an IC.

The cooling unit 70 cools the interior of the unit to decrease the temperature of a component including the heat generating component in the unit as well as the temperature inside the unit, and inhibit an increase in the temperature of the heat generating component. The cooling unit 70 is brought into operation to be able to decrease the temperature of the heat generating component in the unit and extend the life of the heat generating component and the life of the unit. A water-cooling micro cooler can be employed as the cooling unit 70.

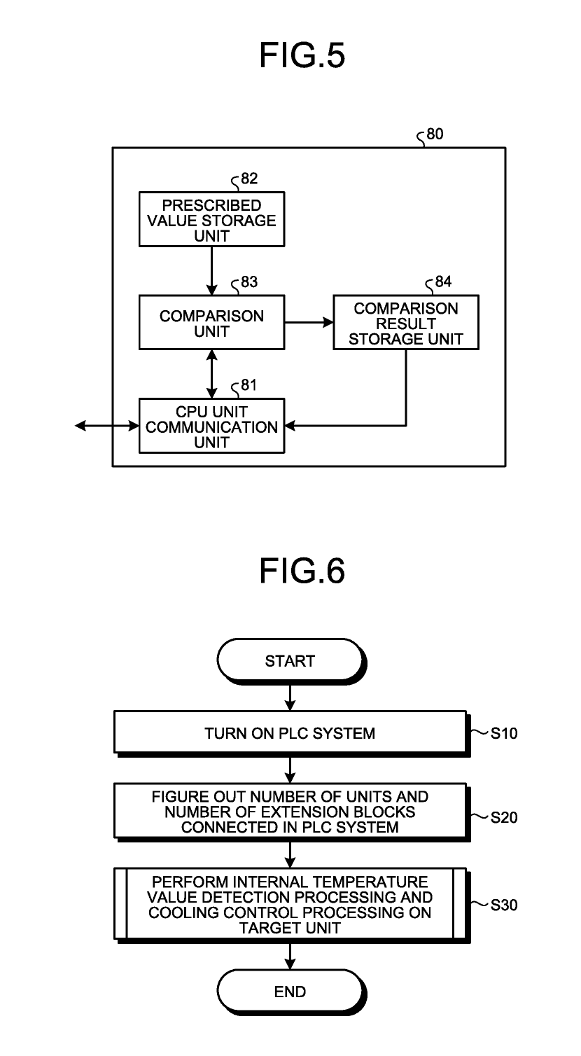

FIG. 5 is a block diagram schematically illustrating a functional configuration of the temperature control management unit 80 according to the first embodiment. The temperature control management unit 80 includes a CPU unit communication unit 81 being a communication function unit, a prescribed value storage unit 82, the comparison unit 83 and a comparison result storage unit 84. The temperature control management unit 80 can be composed of an electronic circuit with use of an IC.

The CPU unit communication unit 81 has a function of communicating information with the unit communication unit 51 of the CPU unit 12 and another unit via the internal bus 15 and the bus connector 16. The CPU unit 12 can read, through the CPU unit communication unit 81, the temperature value detected in each unit and stored in the temperature value storage unit 53.

The prescribed value storage unit 82 stores a prescribed reference temperature value that is lower by a predetermined temperature than a temperature at which heat possibly causes harm to a normal operation of the PLC system 1 when the PLC system 1 is operated. That is, the prescribed value storage unit 82 stores for each unit the prescribed reference temperature value that is lower than the temperature at which the heat possibly causes harm to a normal operation of each of the CPU unit 12, the target units 13-1 to 13-4 and the end cover 14. The prescribed reference temperature value will be hereinafter referred to as a prescribed value. The prescribed value is, for example, set to 60° C. when 65° C. is an upper limit of the internal temperature value at which a certain unit can be operated normally. The prescribed value is a reference value used in determining whether or not to operate the cooling unit 70 of each unit, and is an allowable upper limit of the internal temperature value of each unit when the temperature value falls within a normal range. The prescribed value is set individually for each of the CPU unit 12, the target units 13-1 to 13-4 and the end cover 14 and stored in advance in the prescribed value storage unit 82.

The comparison unit 83 compares the temperature value inside the unit input from the unit communication unit 51 of the temperature monitoring unit 50 in the CPU unit 12 or another unit with the prescribed value corresponding to each unit and stored in the prescribed value storage unit 82, and stores a result of the comparison in the comparison result storage unit 84. That is, the comparison unit 83 causes the comparison result storage unit 84 to store, for each unit, the result of the comparison between the temperature value inside the unit and the prescribed value.

The comparison result storage unit 84 stores the result of the comparison between the temperature value inside a certain unit and the prescribed value, the comparison being executed by the comparison unit 83.

The CPU 90 performs communication within the CPU unit 12 and with another unit, and is a control unit managing control of the entire PLC system.

The display unit 100 is a display unit that displays the temperature value inside each unit. The use of the display unit 100 allows the CPU unit 12 to monitor the internal temperature of each unit. The display unit 100 can also display various information within the PLC system 1. A display device such as a liquid crystal display (LCD) can be employed as the display unit 100.

The functional processing unit 110 is a functional unit that performs processing unique to each unit. The functional processing unit 110 communicates with the CPU unit 12 to perform predetermined processing on the basis of an instruction from the CPU unit 12, for example. The functional processing unit 110 can be composed of an electronic circuit with use of an IC.

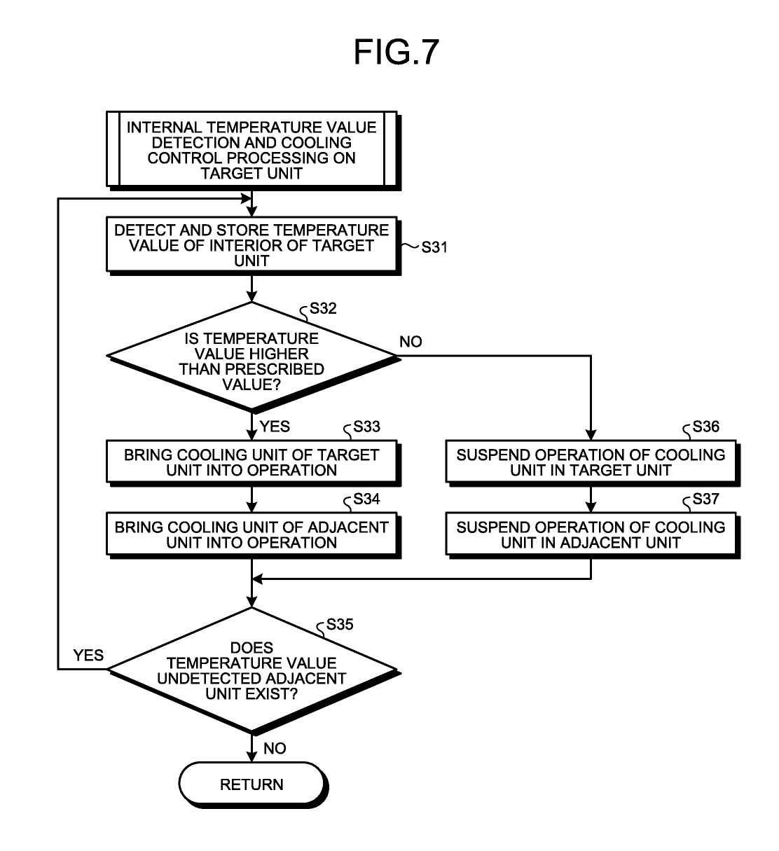

Now, temperature control processing performed in the unit of the PLC system 1 will be described. FIG. 6 is a flowchart illustrating an example of a procedure of the temperature control processing performed in the unit of the PLC system 1 according to the first embodiment. FIG. 7 is a flowchart illustrating an example of a procedure of internal temperature value detection processing and cooling control processing, which are included in the temperature control processing performed in the unit, for a target unit according to the first embodiment, and illustrates in detail the processing performed in step S30 of the flowchart illustrated in FIG. 6.

First in step S10, the power of the PLC system 1 is turned on to allow the power supply unit 11 to supply a voltage to each unit in the basic block 10 via the bus connector 16 connecting the units. The PLC system 1 is thus started up. With the voltage supplied to each unit, the unit communication unit 51 of each unit is ready for communication.

Next in step S20, the CPU 90 accesses each unit via the internal bus 15 and the bus connector 16, and performs processing to figure out the number of units and the number of extension blocks connected in the PLC system 1. The CPU unit 12 acquires a state of the arrangement of the units in the basic block 10 of the PLC system 1, for example. The CPU unit 12 acquires the state of the arrangement of the units in the basic block 10 by acquiring a management number stored in a non-volatile memory (not shown) in each unit, for example. Each unit then executes initial processing on the basis of control by the CPU 90 of the CPU unit 12, and is thereafter subjected to processing. The PLC system 1 is thus brought into operation.

After that, in step S30, the internal temperature value detection processing and the cooling control processing are performed on a target unit subjected to the internal temperature value detection processing and the cooling control processing. Step S30 is performed intermittently after the predetermined processing is performed by the CPU 90, in a predetermined cycle, or at the time of resetting the PLC system 1. The target unit is any of the CPU unit 12 to the end cover 14 in the basic block excluding the power supply unit 11. Here, there will be described a case where the end cover 14 is first treated as the target unit.

First in step S31, the temperature value inside the target unit is detected and stored. That is, the CPU unit communication unit 81 of the CPU unit 12 outputs the unit internal temperature value detection instruction information to the end cover 14. The unit internal temperature value detection instruction information is output intermittently after the predetermined processing is performed by the CPU 90, in a predetermined cycle, or at the time of resetting the PLC system 1. The unit internal temperature value detection instruction information is input to the temperature value detection unit 52 via the unit communication unit 51 of the temperature monitoring unit 50 in the end cover 14. The temperature value detection unit 52 of the end cover 14 detects the temperature value inside the own unit on the basis of the unit internal temperature value detection instruction information being input. The temperature value detection unit 52 of the end cover 14 then outputs the detected temperature value to the temperature value storage unit 53. The temperature value storage unit 53 of the end cover 14 stores the temperature value output from the temperature value detection unit 52. The temperature value storage unit 53 may store the temperature value in association with the time of storage, for example. Once the temperature value is stored in the temperature value storage unit 53, the unit communication unit 51 of the end cover 14 outputs the stored temperature value to the CPU unit 12 as a response to the unit internal temperature value detection instruction information. The temperature monitoring processing for the end cover 14 ends upon completion of the aforementioned processing.

Note that the temperature value stored in the temperature value storage unit 53 may be output to the CPU unit 12 in response to a temperature value read request notification transmitted from the CPU unit communication unit 81 to the unit communication unit 51 of the end cover 14. In this case, the unit communication unit 51 of the end cover 14 transmits the temperature value stored in the temperature value storage unit 53 to the CPU unit 12 in response to the temperature value read request notification.

The temperature value output from the end cover 14 is input to the comparison unit 83 of the temperature control management unit 80 via the CPU unit communication unit 81 of the temperature control management unit 80 in the CPU unit 12. Once receiving input of the temperature value output from the end cover 14, in step S32, the comparison unit 83 compares the temperature value input from the end cover 14 with a prescribed value set for the end cover 14. That is, the comparison unit 83 reads the prescribed value for the end cover 14 from the prescribed value storage unit 82. The comparison unit 83 then compares the temperature value input from the end cover 14 with the prescribed value for the end cover 14 acquired from the prescribed value storage unit 82. Specifically, the comparison unit 83 determines whether or not the temperature value input from the end cover 14 is higher than the prescribed value.

When the temperature value input from the end cover 14 is higher than the prescribed value (Yes in step S32), the comparison unit 83 outputs the temperature value input from the end cover 14 and compared with the prescribed value to the comparison result storage unit 84, which stores the temperature value. The comparison unit 83 then outputs the temperature value, which is stored in the comparison result storage unit 84 when the temperature value is higher than the prescribed value, to the display unit 100 via the CPU unit communication unit 81. The display unit 100 receiving input of the temperature value displays the temperature value to indicate that the temperature value of the end cover 14 is higher than the prescribed value. With the display unit 100 indicating that the temperature value of the end cover 14 is higher than the prescribed value, a user can visually recognize that the end cover 14 requires cooling.

The comparison unit 83 may also output temperature increase information being a temperature difference between the temperature value and the predetermined value along with the temperature value to the comparison result storage unit 84, which then stores the information and the temperature value. The comparison unit 83 can thus output the temperature increase information along with the temperature value to the display unit 100 and cause the display unit to display the information and the temperature value.

The comparison unit 83 also performs processing to instruct control on the cooling unit 70 of the end cover 14 on the basis of the comparison result. When the temperature value input from the end cover 14 is higher than the prescribed value (Yes in step S32), the comparison unit 83 performs processing in step S33 to bring into operation the cooling unit 70 of the end cover 14 being the target unit. That is, the comparison unit 83 outputs the cooling unit operation instruction information to the cooling control unit 60 of the end cover 14.

Upon receiving input of the cooling unit operation instruction information, the cooling control unit 60 of the end cover 14 performs processing to bring the cooling unit 70 of the end cover 14 into operation on the basis of the cooling unit operation instruction information. When the cooling unit 70 of the end cover 14 is already in operation, the cooling control unit 60 of the end cover 14 performs control to continue the operation of the cooling unit 70.

Next in step S34, the comparison unit 83 performs processing to bring into operation the cooling unit 70 of a unit arranged adjacent to the end cover 14 being the target unit. That is, the comparison unit 83 also outputs the cooling unit operation instruction information to the cooling control unit 60 of the unit arranged adjacent to the end cover 14. Here, the end cover 14 is located at the end of the basic block. The comparison unit 83 thus outputs the cooling unit operation instruction information to the cooling control unit 60 of a unit that is arranged one unit to the side of the power supply unit 11 relative to the end cover 14. That is, the comparison unit 83 outputs the cooling unit operation instruction information to the cooling control unit 60 of the target unit 13-4.

Upon receiving input of the cooling unit operation instruction information, the cooling control unit 60 of the target unit 13-4 performs processing to bring the cooling unit 70 of the target unit 13-4 into operation on the basis of the cooling unit operation instruction information. The processing is performed since the temperature inside the unit adjacent to the unit with the high temperature value is increased quickly by the heat of the unit with the high temperature value. When the cooling unit 70 of the target unit 13-4 is already in operation, the cooling control unit 60 of the target unit 13-4 performs control to maintain the operating state of the cooling unit 70.

The end cover 14 being located at the end of the basic block, the comparison unit 83 outputs the cooling unit operation instruction information to the cooling control unit 60 of the unit that is arranged one unit to the side of the power supply unit 11 relative to the end cover 14. However, when the internal temperature value is detected from a unit arranged between the power supply unit 11 and the end cover 14, the comparison unit 83 outputs the cooling unit operation instruction information to the cooling control unit 60 of each of two units arranged adjacent to both sides of the target unit of which the internal temperature value is detected.

Next in step S35, the comparison unit 83 determines whether or not there is a unit, namely a temperature value undetected adjacent unit, from which the internal temperature value is not yet detected in the series of aforementioned processing and which is arranged adjacent to the target unit.

When it is determined in step S35 that there exists the temperature value undetected adjacent unit (Yes in step S35), the processing returns to step S31 in which the temperature value undetected adjacent unit is treated as the target unit. Here, the end cover 14 being the end unit, it is determined whether or not there exists a unit arranged one unit to the side of the power supply unit 11 relative to the end cover 14 being the target unit. In the first embodiment, the target unit 13-4 is arranged one unit to the side of the power supply unit 11 relative to the end cover 14. Accordingly, the target unit 13-4 is the temperature value undetected adjacent unit and treated as the target unit to be subjected to the processing in step S31.

When it is determined in step S35 that the temperature value undetected adjacent unit does not exist (No in step S35), the series of temperature control processing is ended.

On the other hand, when the temperature value input from the end cover 14 is lower than or equal to the prescribed value in step S32 (No in step S32), the comparison unit 83 performs processing in step S36 to suspend the operation of the cooling unit 70 of the end cover 14 being the target unit. That is, the comparison unit 83 outputs the cooling unit suspension instruction information to the cooling control unit 60 of the end cover 14. Note that the comparison unit 83 may output the temperature value input from the end cover 14 and compared with the prescribed value to the comparison result storage unit 84, which then stores the temperature value.

Upon receiving input of the cooling unit suspension instruction information, the cooling control unit 60 of the end cover 14 performs processing to suspend the operation of the cooling unit 70 of the end cover 14 on the basis of the cooling unit suspension instruction information. When the operation of the cooling unit 70 of the end cover 14 is already suspended, the cooling control unit 60 of the end cover 14 performs control to maintain the suspended state of the cooling unit 70. As a result, the cooling unit 70 need not be brought into operation unnecessarily, whereby power consumption can be reduced.

Next in step S37, the comparison unit 83 performs processing to suspend the operation of the cooling unit 70 of a unit arranged adjacent to the end cover 14 being the target unit. That is, the comparison unit 83 also outputs the cooling unit suspension instruction information to the cooling control unit 60 of the unit arranged adjacent to the end cover 14. Here, the end cover 14 is located at the end of the basic block. The comparison unit 83 thus outputs the cooling unit suspension instruction information to the cooling control unit 60 of the unit that is arranged one unit to the side of the power supply unit 11 relative to the end cover 14. That is, the comparison unit 83 outputs the cooling unit suspension instruction information to the cooling control unit 60 of the target unit 13-4.

Upon receiving input of the cooling unit suspension instruction information, the cooling control unit 60 of the target unit 13-4 performs processing to suspend the operation of the cooling unit 70 of the target unit 13-4 on the basis of the cooling unit suspension instruction information. The processing is performed since the temperature inside the unit adjacent to the target unit with the temperature value falling within a normal range is not increased quickly by the heat of the target unit. The cooling unit 70 thus need not be brought into operation unnecessarily, whereby power consumption can be reduced. When the operation of the cooling unit 70 of the target unit 13-4 is already suspended, the cooling control unit 60 of the target unit 13-4 performs control to maintain the suspended state of the cooling unit 70. The processing proceeds to step S35 after step S37.

In the first embodiment, the six units including the end cover 14 to the CPU unit 12 are subjected to the processing in step S30, namely the processing from step S31 to step S35, in sequence from the end cover 14 toward the CPU unit 12. The processing in step S30 is performed repeatedly on the end cover 14 to the CPU unit 12 intermittently after the predetermined processing is performed by the CPU 90, in the predetermined cycle, or at the time of resetting the PLC system 1 while the PLC system 1 is in operation.

While the processing in step S30 is performed successively in order from the end cover 14 to the CPU unit 12 in the aforementioned description, the processing in step S30 may instead be performed in order from the end cover 14 to the CPU unit 12.

Moreover, while the display unit 100 is provided in the CPU unit 12 in the aforementioned description, a display unit having the same function as the display unit 100 may be arranged within the basic block. Alternatively, a display device having the same function as the display unit 100 may be provided outside the basic block.

According to the first embodiment as described above, the temperature monitoring unit 50, the cooling control unit 60 and the cooling unit 70 are provided in each of the CPU unit 12, the target units 13-1 to 13-4 and the end cover 14 of the PLC system 1. The internal temperature value of each unit can thus be detected and monitored. The temperature control management unit 80 is also provided in the CPU unit 12. Accordingly, temperature management control in each unit can be performed by controlling the cooling processing in each unit on the basis of the result of the comparison between the temperature value detected by the temperature monitoring unit 50 and the prescribed value.

That is, while the PLC system 1 is in operation, the temperature monitoring unit 50 of each unit detects and stores the internal temperature value intermittently at an arbitrary predetermined timing. The temperature value inside the unit is monitored at the arbitrary predetermined timing, whereby an increase in the temperature value inside the unit caused by heating as well as power consumption required for the monitoring of the temperature value resulting from the monitoring of the temperature value inside the unit can be reduced as compared to a case where the temperature value inside the unit is continuously monitored.

The temperature control management unit 80 of the CPU unit 12 acquires the temperature value detected and stored in each unit via the bus connector 16 connecting the units. The temperature control management unit 80 compares the temperature value with the prescribed value, and, when the temperature value is higher than the prescribed value, the cooling control unit 60 brings the cooling unit 70 into operation. The cooling unit 70 implemented in each unit is brought into operation to be able to individually prevent the increase in temperature inside each and every unit. The cooling control unit 60 suspends the operation of the cooling unit 70 when the temperature value is lower than or equal to the prescribed value. Therefore, the cooling unit 70 is brought into operation only when the temperature value inside the unit is higher than the prescribed value, whereby the power consumption can be reduced as compared to when the unit is cooled at all times. Moreover, the structure can be simple in this case since the temperature control management unit 80 is provided only in the CPU unit 12.

The temperature monitoring unit 50 stores the temperature value so that monitoring of the temperature value by the temperature monitoring unit 50 and the processing by the temperature control management unit 80 need not be performed successively. That is, the processing by the temperature monitoring unit 50 and the processing by the temperature control management unit 80 are performed at different timings to be able to prevent heating of the CPU unit 12 in the same timing.

The temperature monitoring unit 50 of each unit detects the temperature value inside each unit and, when the temperature value is higher than the prescribed value, displays to that effect or displays the temperature value in the display unit 100 so that a user can visually recognize a unit that requires cooling. Moreover, the user can acknowledge that the temperature of the unit is within the normal range when the display is not displayed on the display unit 100.

According to the first embodiment, the cooling unit 70 of the target unit with the temperature value higher than the prescribed value is brought into operation while the unit adjacent to the target unit is cooled at the same timing as the target unit. As a result, the increase in the temperature value of a component inside the adjacent unit can be prevented at an early stage so that the life of the component inside the adjacent unit and the life of the unit can be extended. In the PLC system of the direct unit connection type, the units arranged adjacent to each other are directly connected while in contact with each other. This causes the temperature inside the unit to be increased easily by the influence of heat of the adjacent unit, whereby the increase in the temperature of the unit needs to be prevented. According to the first embodiment, the target unit with the temperature value higher than the prescribed value as well as the adjacent unit are cooled to be able to prevent the increase in the temperature of the adjacent units.

In the PLC system of the direct connection type of first embodiment where the adjacent units are connected via the bus connector while in contact with each other, the unit for which the increase in the internal temperature needs to be prevented can be individually detected and cooled even when the number of units mounted is changed, whereby the temperature value inside the unit can be controlled with the minimum power consumption required.

Moreover, in the PLC system of the direct connection type of the first embodiment where the adjacent units are connected via the bus connector while in contact with each other, the internal temperature can be controlled to temperature appropriate for each unit at an arbitrary timing even when the number of units mounted is changed, whereby the degree of flexibility in controlling the internal temperature value can be increased.

Therefore, the PLC system according to the first embodiment in which the CPU unit is connected to the unit having another function can control the temperature value inside the unit with low power consumption.

### Second Embodiment

While the first embodiment illustrates the case where the PLC system is formed of only the basic block, a second embodiment illustrates a case where a PLC system is formed of a basic block and an extension block.

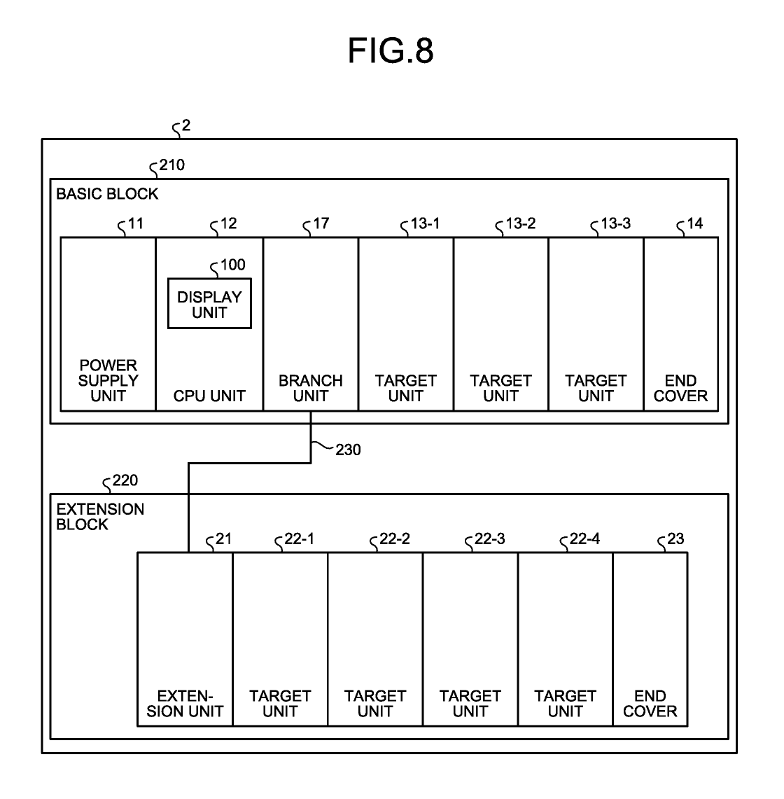

FIG. 8 is a diagram schematically illustrating an example of the configuration of a PLC system 2 according to the second embodiment. The PLC system 2 includes one basic block 210 and an extension block 220 connected to the basic block 210 via an extension cable 230.

The basic block 210 includes a power supply unit 11, a CPU unit 12, target units 13-1 to 13-3, an end cover 14 and a branch unit 17. The branch unit 17 is provided when a block besides the basic block 210 is added and provided at an arbitrary position between the CPU unit 12 and the end cover 14. The branch unit 17 includes a temperature monitoring unit 50, a cooling control unit 60 and a cooling unit 70 described in the first embodiment. The branch unit 17 can communicate with another unit via a communication unit included in the unit.

The extension block 220 includes an extension unit 21 being a starting end and a connection point for a voltage supplied from the power supply unit 11 to the extension block 220, target units 22-1 to 22-4, and an end cover 23 being an end unit. All units in the extension block 220 are connected via a bus connector 16 connected to an internal bus 15 in each unit while adjacent units are in contact with each other. The extension unit 21, the target units 22-1 to 22-4, and the end cover 23 each includes the temperature monitoring unit 50, the cooling control unit 60 and the cooling unit 70 described in the first embodiment. The extension unit 21, the target units 22-1 to 22-4 and the end cover 23 can each communicate with another unit via a communication unit included in each unit.

The branch unit 17 of the basic block 210 and the extension unit 21 of the extension block 220 are connected to each other by the extension cable 230. The extension cable 230 enables the supply of voltage from the power supply unit 11 of the basic block 210 to the extension block 220 as well as communication between the basic block 210 and the extension block 220 via the branch unit 17. Note that a component identical to that of the first embodiment will not be described. When another extension block is to be added, such block can be constructed in the same manner as the extension block 220. This means that a branch unit is newly provided in the extension block 220. The branch unit and a new extension unit are then connected to each other by an extension cable.

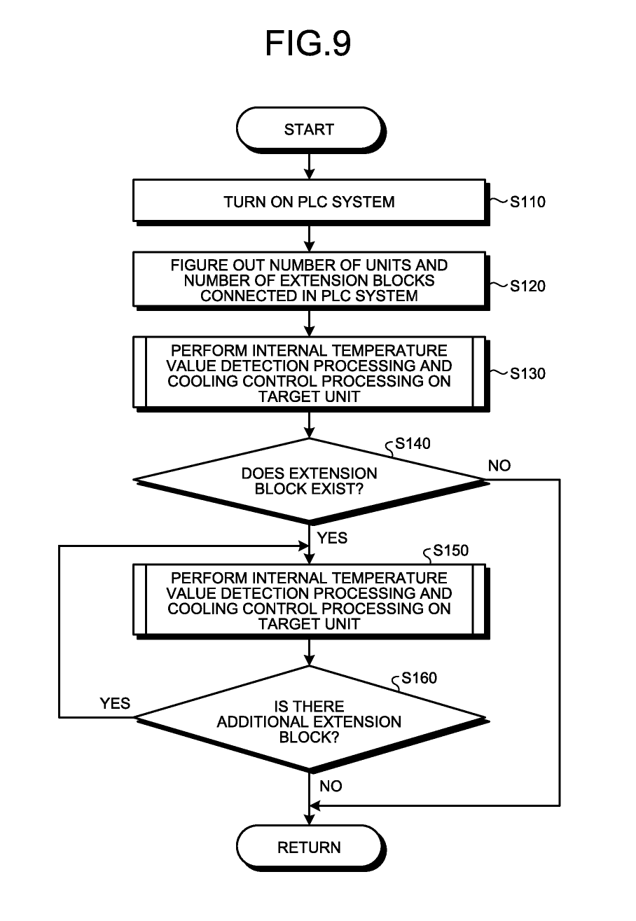

Now, temperature control processing performed in the unit of the PLC system 2 will be described. FIG. 9 is a flowchart illustrating an example of a procedure of temperature monitoring processing according to the second embodiment.

First in step S110, the power of the PLC system 2 is turned on to allow the power supply unit 11 to supply a voltage to each unit each unit of the basic block 210 via the bus connector 16 connecting the units. The power supply unit 11 also supplies a voltage to each unit of the extension block 220 connected to the branch unit 17 via the extension cable 230. The PLC system 2 is thus started up. With the voltage supplied to each unit, a unit communication unit 51 of each unit is ready for communication.

Next in step S120, a CPU 90 accesses each unit of the basic block 210 and the extension block 220 via the internal bus 15, the bus connector 16 and the extension cable 230, and performs processing to figure out the number of units and the number of extension blocks connected in the PLC system 2. Each unit of the basic block 210 and the extension block 220 then executes initial processing on the basis of control by the CPU 90 of the CPU unit 12, and is thereafter subjected to processing. The PLC system 2 is thus brought into operation.

Then in step S130, internal temperature value detection processing and cooling control processing are performed on a target unit to be subjected to the internal temperature value detection processing and cooling processing intermittently after predetermined processing is performed by the CPU 90, in a predetermined cycle, or at the time of resetting the PLC system 1. The target unit is any of the CPU unit 12 to the end cover 14 in the basic block 210 excluding the power supply unit 11, and includes the branch unit 17. Here, there will be described a case where the end cover 14 is first treated as the target unit. The processing performed in step S130 is the same as the processing performed in step S30 described with reference to FIG. 7 in the first embodiment.

After the processing in step S130 is executed on each unit from the CPU unit 12 to the end cover 14 in the basic block 210, a comparison unit 83 determines whether or not there is an extension block connected to the basic block 210 in step S140.

When it is determined in step S140 that there exists the extension block connected to the basic block 210 (Yes in step S140), in step S150, the internal temperature value detection processing and the cooling control processing are performed on a unit in the extension block as the target unit. The target unit in this case corresponds to each unit in the extension block 220. The processing performed in step S150 is the same as the processing performed in step S30 described with reference to FIG. 7 in the first embodiment. Here, there will be described a case where the end cover 23 is first treated as the target unit. That is, in step S150, the six units including the end cover 23 to the extension unit 21 are subjected to the processing identical to that in step S30 in sequence from the end cover 23 toward the extension unit 21.

After the processing in step S150 is executed on each unit from the end cover 23 to the extension unit 21, the comparison unit 83 determines in step S160 whether or not there is another extension block, or an extension block connected to the extension block 220.

When it is determined in step S160 that there exists another extension block (Yes in step S160), the processing returns to step S150 in which each unit in the extension block is treated as the target unit. When it is determined in step S160 that another extension block does not exist (No in step S160), the series of temperature control processing is ended.

On the other hand, when it is determined in step S140 that there is no extension block connected to the basic block 210 (No in step S140), the series of temperature control processing is ended.

Note that while the processing in step S150 is performed successively in order from the end cover 23 to the extension unit 21 in the aforementioned description, the processing in step S150 may instead be performed in order from the extension unit 21 to the end cover 23.

According to the second embodiment as described above, each unit in the extension block 220 is treated as the target unit and subjected to the internal temperature value detection processing and the cooling control processing as with the first embodiment. As a result, the temperature value inside each unit of the extension block 220 can be detected and monitored as with the first embodiment, whereby the temperature management control can be performed on each unit.

Therefore, according to the second embodiment, the PLC system including the extension block as well as the CPU unit connected to the unit having another function can control the temperature value inside the unit with low power consumption.

### Third Embodiment

In the first and second embodiments, the internal temperature value detection processing and the cooling control processing are performed in sequence from the unit located at one end of the row of units, each being the target unit, to the unit located at another end in the basic block or the extension block. Alternatively, the internal temperature value detection processing and the cooling control processing may be performed on only one arbitrary unit as the target unit among the row of units, each being the target unit, in the basic block or the extension block.

In this case, selective temperature value detection instruction information may be externally input to a CPU unit communication unit 81, the information providing an instruction to select one arbitrary unit among the row of units in the basic block or the extension block as the target unit. The CPU unit communication unit 81 may also hold in advance the selective temperature value detection instruction information targeting a specific unit. On the basis of the selective temperature value detection instruction information, the CPU unit communication unit 81 outputs selective unit internal temperature value detection instruction information, for which the target unit is the one arbitrary unit, to only a selected unit. Upon receiving input of the selective unit internal temperature value detection instruction information, the selected unit and a CPU unit 12 execute the processing in step S30 excluding step S35.

Accordingly, in a third embodiment, the internal temperature value detection processing and the cooling control processing can be performed on only the specific unit being selected. That is, the temperature value inside the unit can be controlled only for the specific unit by determining whether the internal temperature value is extremely high and whether cooling is required.

### Fourth Embodiment

In the first and second embodiments, the internal temperature value detection processing and the cooling control processing are performed on the unit intermittently at a timing such as after the predetermined processing is performed by the CPU 90, in the predetermined cycle, or at the time of resetting the PLC system 1. On the other hand, the aforementioned processing in step S30, step S130 and step S150 can also be performed at an arbitrary timing other than the timing such as after the predetermined processing is performed by the CPU 90 or in the fixed cycle. In this case, additional temperature value detection instruction information may be externally input to a CPU unit communication unit 81, the information providing an instruction to output an additional piece of unit internal temperature value detection instruction information from the CPU unit communication unit 81. The CPU unit communication unit 81 outputs the unit internal temperature value detection instruction information as described above on the basis of the additional temperature value detection instruction information.

With the additional temperature value detection instruction information being externally input to the CPU unit communication unit 81, the internal temperature value of the unit in which a cooling unit 70 is brought into operation by the aforementioned series of processing can be detected once again. Then when the temperature value is lower than or equal to a prescribed value, the processing in each of step S36 and step S37 is performed to be able to suspend the operation of the cooling unit 70 of the unit as well as the cooling unit 70 of an adjacent unit. Therefore, in a fourth embodiment, the cooling unit 70 need not be brought into operation unnecessarily, whereby power consumption can be reduced.

Note that while the temperature control processing on the functional unit other than the power supply unit 11 is described as an example in the aforementioned embodiments, the aforementioned structure and processing of the power supply unit 11 may also be applied to the entire functional block including the power supply unit 11. In this case, the power supply unit 11 includes a temperature monitoring unit 50, a cooling control unit 60, the cooling unit 70 and a functional processing unit 110 as is the case with target units 13-1 to 13-4 and an end cover 14. The temperature control processing can then be performed on the power supply unit 11 by a CPU unit 12 and the power supply unit 11 performing the processing described in the aforementioned embodiments.

The configuration described in the aforementioned embodiments illustrates an example of the content of the present invention and can be combined with another known technique or partly omitted or modified without departing from the gist of the present invention.

### REFERENCE SIGNS LIST

10 basic block, 11 power supply unit, 12 CPU unit, 13-1 to 13-4 target unit, 14 end cover, 15 internal bus, 16 bus connector, 17 branch unit, 21 extension unit, 22-1 to 22-4 target unit, 23 end cover, 50 temperature monitoring unit, 51 unit communication unit, 52 temperature value detection unit, 53 temperature value storage unit, 60 cooling control unit, 70 cooling unit, 80 temperature control management unit, 81 CPU unit communication unit, 82 prescribed value storage unit, 83 comparison unit, 84 comparison result storage unit, 100 display unit, 110 functional processing unit, 210 basic block, 220 extension block, 230 extension cable.

1-10. (canceled)

11. A central operation processing unit of a programmable logic controller system whose control target is a functional unit including a temperature monitoring unit to intermittently detect a temperature value of the interior of a unit and a cooling unit to cool the interior of the unit, the central operation processing unit comprising:
a temperature control management unit to compare the temperature value detected by the temperature monitoring unit in the functional unit with a prescribed value corresponding to the functional unit and being set in advance individually, and, on the basis of a result of the comparison, control an operation of the cooling unit in the functional unit where the temperature value is detected.

12. The central operation processing unit of a programmable logic controller system according to claim 11, wherein
the central operation processing unit is used in the programmable logic controller system comprising a basic block in which, as functional units, a power supply unit, the central operation processing unit, a general unit having a different function from each of the power supply unit and the central operation processing unit among the functional units, and a first end unit arranged at an end with respect to the power supply unit are arranged adjacent to one another in sequence while in contact with one another and are electrically and communicably connected via connectors connecting the functional units,
the temperature monitoring unit of the general unit is configured to intermittently detect the temperature value of the interior of the general unit at a predetermined timing, and
the temperature control management unit is configured to compare the temperature value detected by the temperature monitoring unit of any of the functional units in the basic block with a prescribed value corresponding to the functional unit in the basic block and being set in advance individually, and, on the basis of a result of the comparison, control an operation of the cooling unit of the functional unit where the temperature value is detected.

13. The central operation processing unit of a programmable logic controller system according to claim 12,
wherein the programmable logic controller system further comprises an extension block to be electrically and communicably connected to the basic block via an extension cable, and wherein
the basic block further includes a branch unit to be arranged between the power supply unit and the first end unit,
the extension block is configured such that, as the functional units, an extension unit connected to the branch unit of the basic block via the extension cable, a second end unit arranged at an end with respect to the extension unit, and the general unit arranged between the extension unit and the second end unit are arranged adjacent to one another in sequence while in contact with one another and are electrically and communicably connected via the connector,
each of the branch unit, the extension unit and the second end unit includes the temperature monitoring unit and the cooling unit, and
the temperature control management unit compares a temperature value detected in any of the functional units in the extension block with the prescribed value corresponding to the functional unit in the extension block and being set in advance individually, and, on the basis of a result of the comparison, controls an operation of the cooling unit of the functional unit where the temperature value is detected.

14. The central operation processing unit of a programmable logic controller system according to claim 11, wherein
the temperature control management unit performs control processing to start an operation or maintain an operating state of the cooling unit of the functional unit where the temperature value is detected, when the temperature value is higher than the prescribed value.

15. The central operation processing unit of a programmable logic controller system according to claim 14, wherein
the temperature control management unit performs control processing to start an operation or maintain the operating state of the cooling unit of the functional unit arranged adjacent to the functional unit, the cooling unit of which is brought into operation.

16. The central operation processing unit of a programmable logic controller system according to claim 11, wherein
the temperature control management unit performs control processing to suspend the operation or maintain a suspended state of the cooling unit of the functional unit where the temperature value is detected, when the temperature value is lower than or equal to the prescribed value.

17. The central operation processing unit of a programmable logic controller system according to claim 16, wherein
the temperature control management unit performs control processing to suspend the operation or maintain the suspended state of the cooling unit of the functional unit arranged adjacent to the functional unit, the cooling unit of which is suspended.

18. The central operation processing unit of a programmable logic controller system according to claim 11, wherein
the temperature monitoring unit detects a temperature value of the interior of any of the functional units specified by the temperature control management unit.

19. The central operation processing unit of a programmable logic controller system according to claim 12, wherein
the temperature monitoring unit detects a temperature value of the interior of any of the functional units at an arbitrary timing specified by the temperature control management unit other than the predetermined timing.

20. The central operation processing unit of a programmable logic controller system according to claim 11, wherein
the temperature monitoring unit includes a storage unit to store the temperature value being detected.

21. The central operation processing unit of a programmable logic controller system according to claim 20, comprising a display unit to display the temperature value stored in the storage unit.
